(19) United States
(12) Patent Application Publication
(10) Pub. No.: US 2009/0007014 A1
(43) Pub. Date: Jan. 1, 2009

(54) Center locked lists

(75) Inventors: Christen E. Coomer, Seattle, WA (US); Marc S. Oshiro, Seattle, WA (US); Suzan Marashi, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/823,210

(22) Filed: Jun. 27, 2007

(51) Int. Cl. G06F 3/048

(52) U.S. Cl. 715/830

(57) ABSTRACT

Described is a technology by which a user can quickly locate a data item such as media content. A user may choose a pivot (filtering) category, including an aggregated “all” category, and may enter additional filtering criteria to narrow search results. Representations (e.g., images) of data items for are displayed, including a representation of one data item at a fixed (e.g., centered) selection position. Scrolling among the items is accomplished by moving representations of the data items relative to the fixed selection position. Scrolling may be substantially horizontal or vertical, and the item representation in the selection position may be highlighted relative to other item representations, such as via its relative size, opacity and/or color. Metadata also may be displayed in association with the representation of the data item at the fixed selection position.

### BACKGROUND

Computer users frequently deal with large amounts of information in their file systems, databases, and online search engines. Previous versions of searching programs do not support aggregated searching. For example, users can only search within individual media experiences (music, television, videos) or partner content libraries. Thereafter, each search session requires navigating through a selection screen to filter the search results. Such navigation becomes tedious and compromises the user experience.

Moreover, the presentation of such search results is entirely text based. Images such as thumbnails, album artwork or movie posters are not supported, even though many listed items would benefit from a user seeing visual images rather than solely textual descriptions thereof, such as better sales due to improved user recognition and marketing-related aspects based on an image accompanying an item.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a user can quickly locate a data item via one or more mechanisms, including aspects related to a pivot (filtering) category, possibly other filtering criteria, a fixed selection position (e.g., center-locked scrolling), and/or focusing on a particular item for selection. Representations (e.g., images) of data items of a pivot category are displayed, including a representation of one data item at a fixed (e.g., centered) selection position. The item representations are scrolled by moving another data item into the selection position and moving representations of other items relative to that selection position. Scrolling may be substantially horizontal in response to a left or right directional signaling mechanism, e.g., buttons on a remote control, or may be substantially vertical in response to up or down directional signaling. The item representation in the selection position may be highlighted relative to other item representations, such as via its relative size, opacity and/or color. Metadata also may be displayed in association with the representation of the data item at the fixed selection position.

In one aspect, the user may provide filtering criteria, such as text input that filters the items to only those that match the text. The user also may change the displayed data items by changing the pivot category. One of the pivot categories may be an “all” category that combines data items comprising media content from a plurality of different data sources.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing general components for implementing center locked lists of item images corresponding to a pivot category.

FIGS. 2 and 3 are representations of example user interface display outputs including center locked lists of visible item images corresponding to a pivot category.

FIG. 4 is a flow diagram representing example steps taken with respect to processing user input for navigating center locked lists, including handling pivot category selection and text filtering operations.

FIG. 5 shows an illustrative example of a general-purpose network computing environment into which various aspects of the present invention may be incorporated.

### DETAILED DESCRIPTION

Various aspects of the technology described herein are generally directed towards searching data items (e.g., media content), including across multiple media data source experiences and/or any partner content library that may be filtered and/or separately presented. In one example, search results may be dynamically updated by using one of a series of pivot categories (corresponding to filters) above the search results. This pivot convention facilitates targeting and refining user searches.

Further, a user may filter via filtering criterion or criteria, such as by entering text that filters the presented search results to items having identifiers (e.g., titles) that match the text criterion. Still further, search result items are displayed as representative images (e.g., tiles), including by scrolling one item tile into a center position for possible user selection, thus providing a center locked list, e.g., if selection is requested, it is the centered item that is selected. Highlighting of the centered item also may be performed, to focus attention on the item.

As will be understood, various examples are set forth herein, including one in which search results are displayed as a horizontal list, with one current search item that currently selectable being centered in the list. It is alternatively feasible and equivalent to have a vertical scrolling list with a centered item. In any event, that centered item may be made to stand out via various focusing mechanisms. Such a center-locked scrolling/focus model improves discoverability of a particular item within a set of items. However, these are only non-limiting examples for the purposes of describing the technology. As such, the present invention is not limited to any particular embodiments, aspects, concepts, protocols, formats, structures, functionalities or examples described herein. Rather, any of the embodiments, aspects, concepts, protocols, formats, structures, functionalities or examples described herein are non-limiting, and the present invention may be used various ways that provide benefits and advantages in computing and online advertising technology in general.

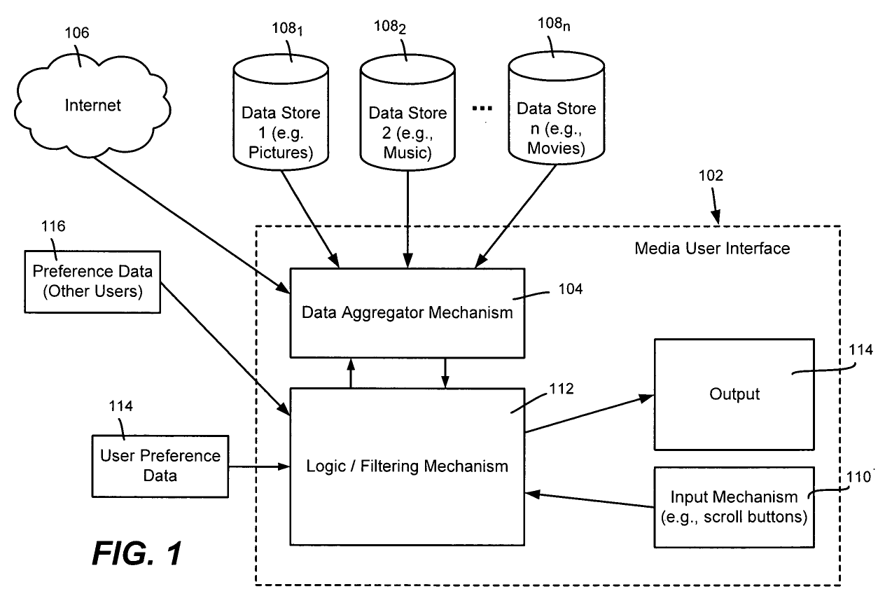

Turning to FIG. 1, there is shown a block diagram representing general components related to data item (e.g., media content) searching using a pivoting model, center locking model and focusing model described herein. In general, a media user interface 102 includes a data aggregator mechanism 104 that is coupled to various sources of media data, possibly including the Internet 106 and/or other data stores 108₁-108ₙ (e.g., local or remote stores of pictures, music, movies, recorded television shows and so forth).

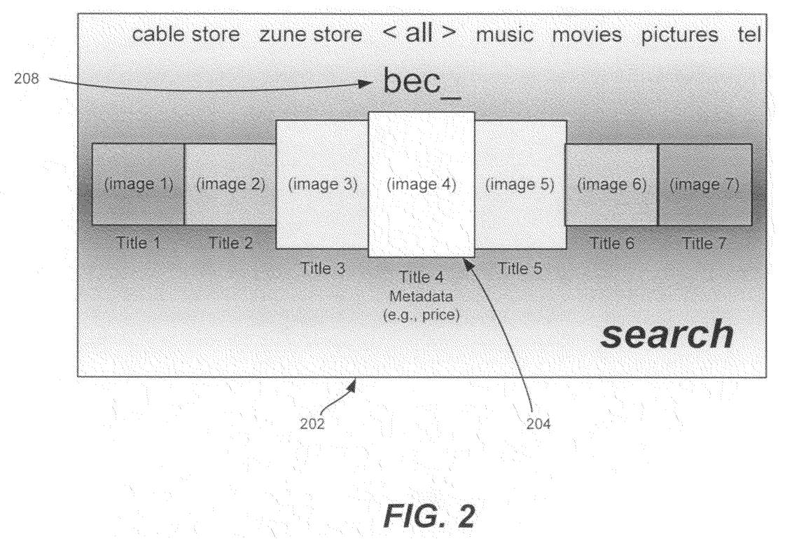

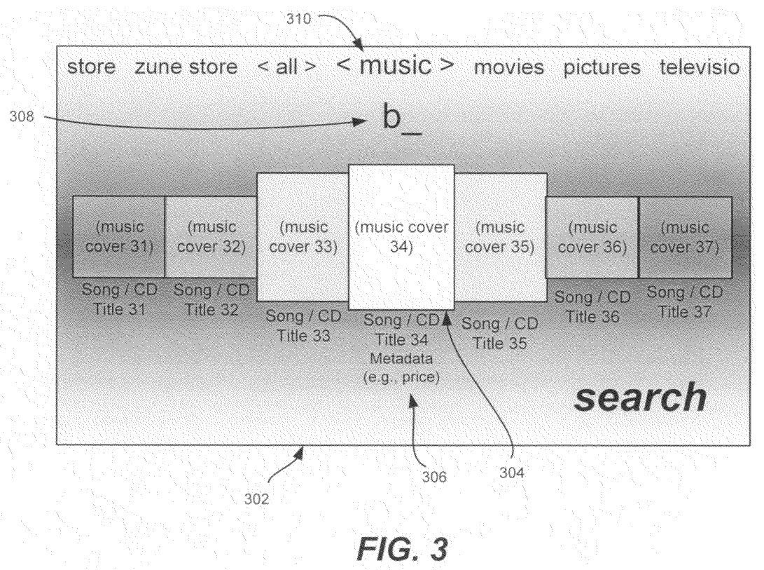

In general, based on user input via an input mechanism 110, such as a remote control device including scrolling (directional) buttons, a keyboard (real or virtual), a pointing device and so forth, a logic/filtering mechanism 112 produces an output 114. Example outputs may be generally along the lines of the screen or program window representations 202 and 302 of FIGS. 2 and 3, respectively.

In general, the logic/filtering mechanism 112 is coupled to the data aggregator mechanism 104 to instruct the data aggregator mechanism 104 as to which data is needed. This may be all data from any available data source 106 and/or 108₁-108ₙ, or any subset of the data available for access, such as movie data only, local data only, and so forth. For example, if the number of available data items is small, the logic filtering mechanism 112 can request all items and thereafter perform filtering on all the items, or can request that only certain items be returned as part of a pre-filtering operation. The data aggregator mechanism 104 searches and/or aggregates the requested results.

With the data and user input, as well as optionally user preference data 116, the logic/filtering mechanism 112 may filter the output 114 in a way that the displayed data items pivot around a user-selected category. User preference data 114 may be used as defaults for a search, or as additional search criteria. Examples of preference data may include user-specified visual effects, specifying content age (e.g., by default, do not show items over ten years old), ordering of pivot categories, and so forth.

As represented in the screen representations 202 and 302 of FIGS. 2 and 3, respectively, the media user interface uses a center locked list as a mechanism for interacting with media content data. For example, a list of data items is displayed to the user as images that are relevant to a pivot category, such as “all” content (FIG. 2), or music content (e.g., song or CD titles in FIG. 3). As can be seen, the “all” pivot category flattens out the hierarchy of items. Further, in actual implementations, the search results presentation may be visually rich. For example, any media type can be displayed, such as album artwork, movie posters, actual image tiles of pictures, and so forth.

As represented in FIGS. 2 and 3, the user may also enter a letter or series of letters in a text entry area (208, 308) to filter the items, whereby a list of only those items that match the text filtering criterion is displayed. For example, in one implementation, the list is a circular list from the beginning of the user-entered letter or letters to the end of that letter or those letters, that is, from “beca” to “becz” in FIG. 2, and from “ba” to “bz” in FIG. 3.

Further, with respect to the center item, a pivot table of information relative to the center tile may be displayed above and below the string of tiles. For example, in FIG. 3, the pivot is the category music 310, and because the letter “b” has been entered, the user can scroll among music items from “ba” to “bz” in this example. As can be seen in FIG. 3, a song or album cover (music cover 34) is presently being displayed as the selectable, centered item 304 along with metadata 306 about that item such as a purchase price. Note that in an alternative implementation, the text (e.g., one or more letters) may be displayed automatically, without user entry, to assist the user in scrolling. The user may edit such text to perform text-based filtering.

In this example, scrolling is horizontal, with the currently selectable item 304 locked in the center until replaced via user (or possibly automated) scrolling, that is, the center locked list is a horizontal list of the items, represented as tiles. Center locking the list keeps the user focused on the main area of the screen, and filtering helps quickly identify the data item of interest.

To this end, “moving” a cursor horizontally (e.g., via left or right directional button pressing) causes new tiles to appear, including a newly focused one as the center tile highlighted by one or more various focusing mechanisms. For example, as represented in FIGS. 2 and 3, the center item 204 and 304 is enlarged. One or more other highlighting mechanisms such as opacity, color (e.g., versus grayscale), animation and so forth may be used instead of or in addition to size (and/or position) to focus attention on a particular item. Note that items proximate the centered item also may be highlighted, typically to some lesser extent, to help draw focus to the center item.

Although not explicitly shown in FIGS. 2 and 3, secondary (or even further, such as tertiary) filtering may also be applied in addition to pivot category and/or alphabetic filtering. For example, content age, content age (or year) range, genre, and so forth may be used to filter and/or re-order (sort) the items that appear under a pivot category. Note that preference data 116 of other users (e.g., most popular titles, frequency, and the like) may be used as a secondary or further filter of items from a pivot category.

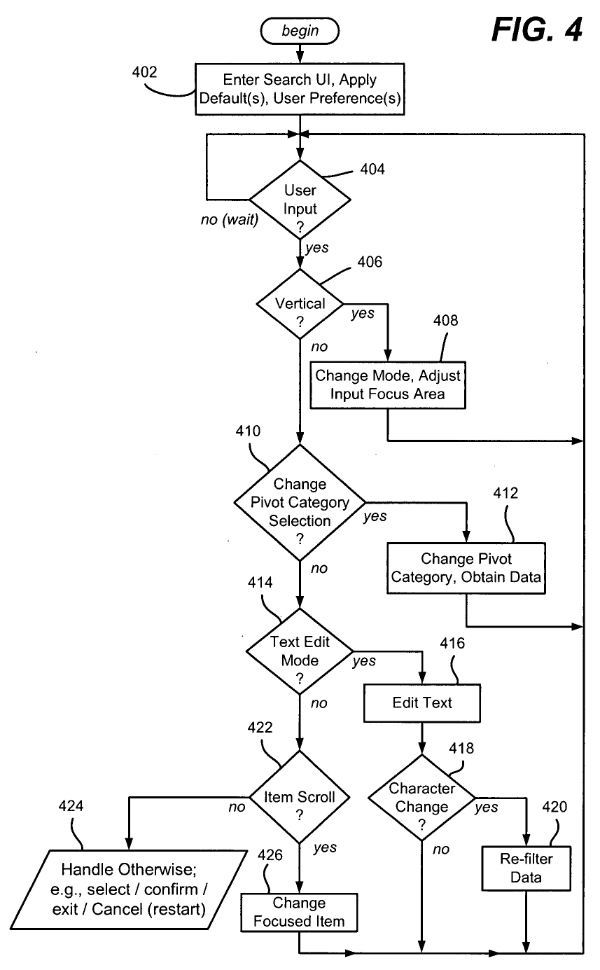

FIG. 4 summarizes example operations that may be handled in center-locked scrolling around a pivot category, such as represented in FIGS. 2 and 3. Step 402 represents the user choosing to open a media search program or the like to begin a search. Any defaults and/or user preferences may be applied, such as to start on a particular search pivot category, obtain certain items (e.g., all if a local only search), and/or configure the display output.

Step 404 represents awaiting some user input with respect to user interaction to control operation. One such type of input is a vertical directional (scroll) command, which in this example gives the user a choice of mode, namely a pivot category choice mode, a text entry mode, and a horizontal scroll/selection mode. For example, in FIG. 3, the user may be visually moved to the pivot category row to make a pivot category choice (the row in which “music” 310 is selectable), the text entry area 308 to edit text for filtering, or the main item row to scroll and select among the items.

Step 408 represents changing the output to highlight where the user is, e.g., in the top pivot category row, in the text entry area, or in the item scrolling row. Note that if a pivot category is not automatically chosen for the user by default, then the user may be initially required to make a category selection, e.g., by scrolling and/or selecting along the top row which lists the available pivot categories.

Step 410 represents determining whether the user is in the pivot category selection mode, including selecting and/or making a change to the pivot category as represented by step 412. Note that in the examples of FIG. 3, an initial selection and/or change is accomplished by a selection button or the like in conjunction with any horizontal scrolling through the pivot categories. For example, in FIG. 2 the user has chosen the “all” pivot category, while in FIG. 3 the user has chosen the “music” pivot category. Step 412 centers and highlights the chosen pivot category, as well as displaying the relevant items for that category.

Step 414 represents evaluating whether the user is in the text edit mode; some text may be required in conjunction with category selection to limit how many items are initially retrieved. Alternatively, text editing may only be available when items are already displayed.

Step 416 represents handling the text editing input, including any allowed cursor movement, insertion, deletion, backspace and/or new character entry. This may be handled as allowing only a single editing command at a time, or alternatively by allowing multiple editing commands in conjunction with some mechanism by which the user indicates text editing is complete, e.g., by changing modes (via vertical scrolling), hitting an enter button, and so forth. In any event, step 418 represents determining whether a character (or at least one character) has changed; if so, step 420 is performed to filter or re-filter the items displayed based on the current characters in the text entry area.

Step 422 represents evaluating whether the user is in the item scrolling mode, and whether the user is attempting to horizontally scroll, in order to appropriately handle the input. If the user is horizontally scrolling and is able to scroll (e.g., there is more than one item), step 426 represents changing the focused item, e.g., moving a new item into the center, and highlighting that item as necessary (an item may be automatically highlighted as a function of its center position).

Step 424 represents handling other input, including other input handling while in the item scroll mode. For example, the user may select an item to purchase, may confirm a selection, may exit the program, may cancel selection without confirming, and so forth. In addition, scrolling may be ignored if there are not at least two items displayed, or if the user is attempting to scroll left beyond the first or right beyond the last item (in a model in which circular scrolling is not allowed). Still other user input may be for other purposes, such as to specify other filtering criteria, e.g., by moving to and clicking a button that provides a filtering dialog, although such an option is not explicitly shown in the examples of FIGS. 2 and 3.

As can be seen, a center lock scrolling and focus model, along with the visual presentation and pivot convention for targeting and refining user searches, provides a valuable tool for a user to quickly locate a data item. Large collections of items, such as media content, may be quickly and intuitively navigated to facilitate location and selection of a particular item.

### EXEMPLARY OPERATING ENVIRONMENT

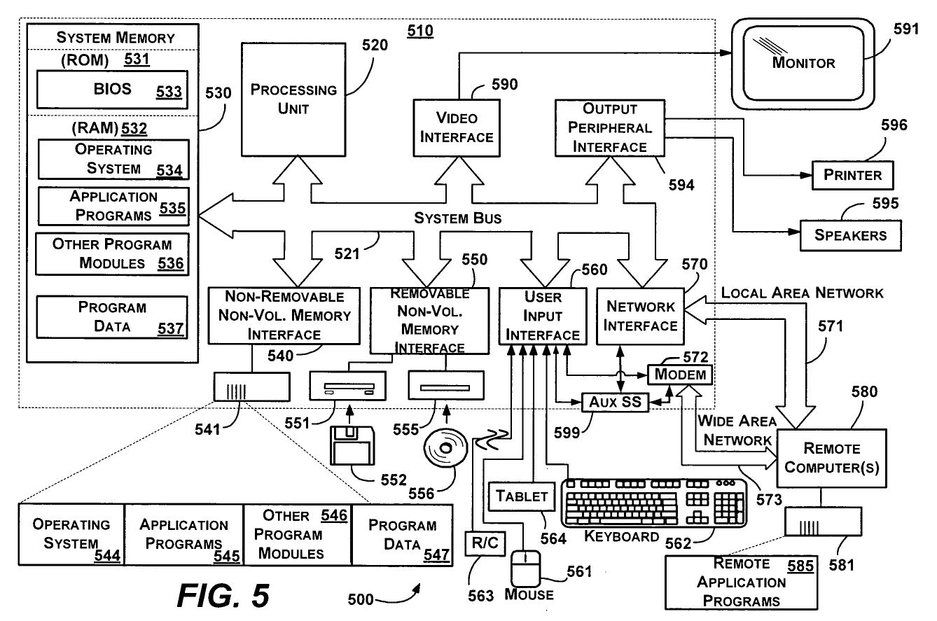

FIG. 5 illustrates an example of a suitable computing system environment 500 on which the center locked list examples represented in FIGS. 1-4 may be implemented, such as on a remote-controlled media center personal computer. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a remote control (R/C) 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. At least one computer-readable medium having computer-executable instructions, which when executed perform steps, comprising:
outputting representations of a subset of data items corresponding to a set of items of a pivot category, including a representation of one data item at a fixed selection position;
detecting actuation of a mechanism directed towards scrolling through the data items, and in response, scrolling the representations of the data items by moving a representation of another data item into the selection position and moving representations of other items relative to that selection position.

2. The computer-readable medium of claim 1 wherein the fixed selection position is substantially centered among the representations of the items.

3. The computer-readable medium of claim 1 wherein scrolling the representations of the items is substantially horizontal, and wherein detecting actuation of the mechanism directed towards scrolling through the data items comprises detecting actuation of a left or right directional signaling mechanism, or wherein scrolling the representations of the items is substantially vertical, and wherein detecting actuation of the mechanism directed towards scrolling through the data items comprises detecting actuation of an up or down directional signaling mechanism.

4. The computer-readable medium of claim 1 having further computer-executable instructions comprising, highlighting the representation of the item in the selection position relative to other representations of items.

5. The computer-readable medium of claim 4 wherein highlighting includes changing at least one of size, opacity or color, or any combination thereof, of the representation of the item in the selection position relative to the representations of other items.

6. The computer-readable medium of claim 1 having further computer-executable instructions comprising, detecting a change to the pivot category, and in response, outputting representations of a different subset of data items corresponding to a set of items of the changed pivot category.

7. The computer-readable medium of claim 1 having further computer-executable instructions comprising, receiving text input, and in response, filtering the set of items of the pivot category based on the text input.

8. The computer-readable medium of claim 1 having further computer-executable instructions comprising, displaying metadata in association with the representation of the data item at the fixed selection position.

9. In a computing environment, a system comprising:
a search user interface;
a data aggregation mechanism associated with the search user interface, the data aggregation mechanism configured to obtain data items from a plurality of data sources; and
logic including an input handling mechanism coupled to the data aggregation mechanism to obtain data items corresponding to a pivot category for displaying representations thereof on the search user interface, including displaying a representation of one item in a fixed selection position, and scrolling in response to user commands by moving data item representations relative to that fixed selection position.

10. The system of claim 9 wherein the data item representations comprise images.

11. The system of claim 9 wherein the fixed selection position is substantially centered among the data item representations.

12. The system of claim 9 wherein moving the data item representations relative to the fixed selection position is substantially horizontal, or wherein moving the data item representations relative to the fixed selection position is substantially vertical.

13. The system of claim 9 wherein the representation of the item in the selection position has a different size, different opacity or different color, or any combination thereof, relative to other data item representations.

14. The system of claim 9 wherein the pivot category is an all category that combines data items comprising media content from a plurality of different data sources.

15. The system of claim 9 wherein the logic further comprises a filtering mechanism, including means for filtering a subset of data items from a larger set of data items based on text input.

16. The system of claim 9 wherein the user interface further includes means for displaying metadata in association with the representation of the data item at the fixed selection position.

17. In a computing environment, a method comprising:
obtaining a set of data items corresponding to a pivot category;
scrolling through the data items by horizontally or vertically moving representations of the items; and
providing a data item for selection by focusing a representation of that data item relative to other items, including by positioning the representation of that data item at a fixed selection position and highlighting that representation relative to other item representations.

18. The method of claim 17 wherein the fixed selection position is substantially centered among the representations of items being displayed, and wherein scrolling through the data items comprises receiving directional signals based on user input.

19. The method of claim 17 further comprising, filtering a subset of data items from a larger set of data items of the pivot category, and wherein scrolling through the data items comprises displaying representations of only the items in the subset.

20. The method of claim 17 further comprising, displaying metadata in association with the representation of the data item at the fixed selection position.
